(19) United States
(12) Patent Application Publication
(10) Pub. No.: US 2003/0102018 A1
(43) Pub. Date: Jun. 5, 2003

(54) Device for rinsing bores

(76) Inventor: Peter Ostermeier, Diessen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/308,360

(22) Filed: Dec. 2, 2002

(30) Foreign Application Priority Data
Dec. 3, 2001 (DE) 101 59 334.1

(51) Int. Cl. B08B 3/00

(52) U.S. Cl. 134/114; 134/167 R; 134/198; 134/201

(57) ABSTRACT

A device for rinsing bores (1) including comprising a rinsing head (2) insertable in a bore (1), a delivery channel (3) for delivery rinsing medium (4) to the rinsing head (2) and having at lest one outlet opening (6) in a region of the rinsing head (2), and a return channel (5) for returning the rinsing medium out of the bore (1) and having at least one return opening (7) in the region of the rinsing head (2).

### BACKGROUND OF THE INVENTION

1. Field of the Invention

The present invention relates to a device for rinsing bores and having a rinsing head insertable in a bore, and a delivery channel for delivering rinsing medium to the rinsing head and having an outlet opening in the region of the rinsing head.

2. Description of the Prior Art

After formation of a bore in a constructional component, which is formed, e.g., of concrete, drillings and, in particular, drilling dust remain in the bore. In certain application, it is undesirable to have a bore, which was formed by drilling, contaminated with drillings. This is particularly undesirable when chemical attachment means is used.

Generally it is known to rinse a bore, which is contaminated with drillings, by using a rinsing device and a rinsing medium. As a rinsing medium, e.g., water or air can be used. The rinsing device generally has a delivery channel for delivering the rinsing medium into the bore.

A drawback of the known device consists in that the rinsing medium, which is delivered into a bore, becomes mixed with the drillings in an uncontrolled manner, and in this state exists the bore. The return rinsing medium, which is intermixed with the drillings, contaminate the bore surrounding.

Another drawback of the known device consists in that the rinsing of a bore is associate with a large consumption of the rinsing medium.

Accordingly, an object of the present invention is to provide a device for rinsing bores that would prevent contamination of the bore surrounding.

Another object of the present invention is to provide a rinsing device that would insure good cleaning of a bore and would have a reduced rinsing medium consumption.

### SUMMARY OF THE INVENTION

These and other objects of the present invention which will become apparent hereinafter, are achieved by providing a return channel for delivering the rinsing medium from the bore and having a return opening in the region of the rinsing head.

Providing a rinsing device having at least one opening in the region of the rinsing head, insures a reduced consumption of the rinsing medium as the use of the rinsing head insures a precise application of the rinsing medium in the bore. Further, a return opening, which is also provided in the region of the rinsing head, insures return of the contaminated rinsing medium through the return channel, without contaminating the environment. The rinsing head can have an arbitrary outer profile such as, e.g., cylindrical, disc-shaped, or ball-shaped profile.

Advantageously, the return opening of the return channel is spaced, in a direction opposite to the insertion direction, from the outlet opening of the delivery channel to insure return of all of the rinsing medium delivered through the delivery channel.

Advantageously, the plane, in which the return opening is located, extends substantially transverse to the insertion direction of the rinsing head in the bore.

The return channel, advantageously, runs coaxially with the delivery channel and surrounds the same.

In order to obtain an optimal rinsing of the bore wall, the outlet openings of the delivery channel are arranged in a plane extending, at least partially, transverse to the insertion direction of the rinsing head. Advantageously, the outlet openings are arranged over the entire circumference of the rinsing head. This insures a uniform cleaning, with rinsing medium, of the entire circumference of the bore wall.

Advantageously, guide means adjoins an end of the rinsing head facing in the direction opposite the insertion direction of the rinsing head. The guide means is, e.g., bar-shaped, which insures an easy guidance of the rinsing head. The guide means includes, preferably a handgun-like handle with a control unit, which insures an easy actuation of the rinsing device.

Advantageously, at the insertion direction side of the guide means, there is provided a splash guard cap that projects beyond the circumference of the guide means. The splash guard cup prevents an uncontrolled flow of the rinsing medium out of the bore. The splash guard cap can have, e.g., a circular cross-section and be provided at its end with a sealing element that is brought into contact with the surface of the constructional component.

The splash guard cap is, advantageously, at least partially displaceable along the guide means to insure an adequate sealing of the bore when the rinsing head is displaced into the bore.

Advantageously, the splash guard cap is spring-biased, with respect to the guide means, in the insertion direction of the rinsing head to avoid a manual adjustment of the splash guard cap relative to the surface of the constructional component.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the Drawings:

FIG. 1 shows a cross-sectional view of a device for rinsing bores according to the present invention in its initial position;

FIG. 1A shows a cross-sectional view of a section 1A in FIG. 1 at an increased scale;

FIG. 2 shows a cross-sectional view of the device shown in FIG. 1 in a position in which it extends into a rinsed bore;

FIG. 2A shows a cross-sectional view of a section IIA in FIG. 2 at an increased scale; and

FIG. 3 shows a cross-sectional view along line III-III in FIG. 1.

### DETAILED DESCRIPTION OF THE PREFERRED EMBODIMENT

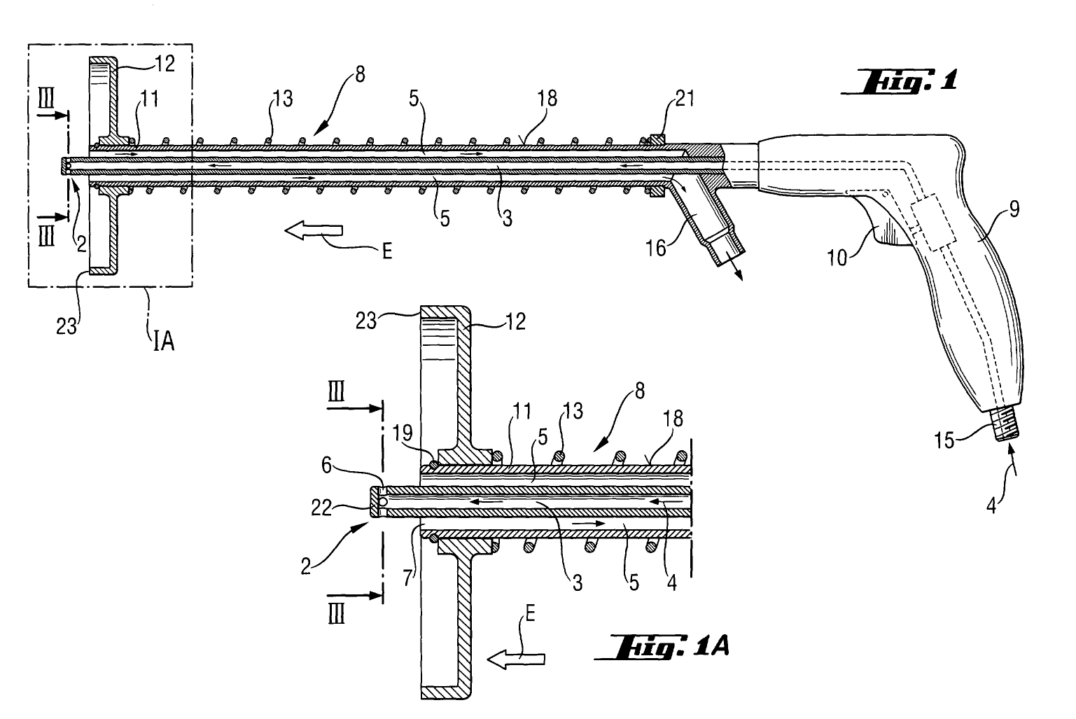

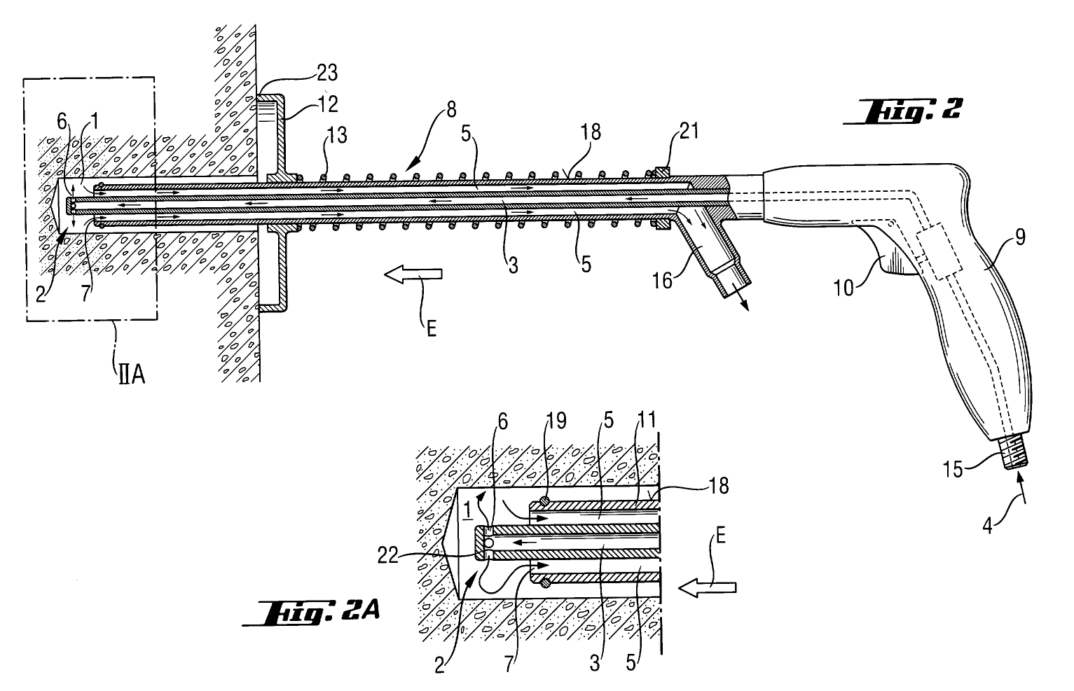

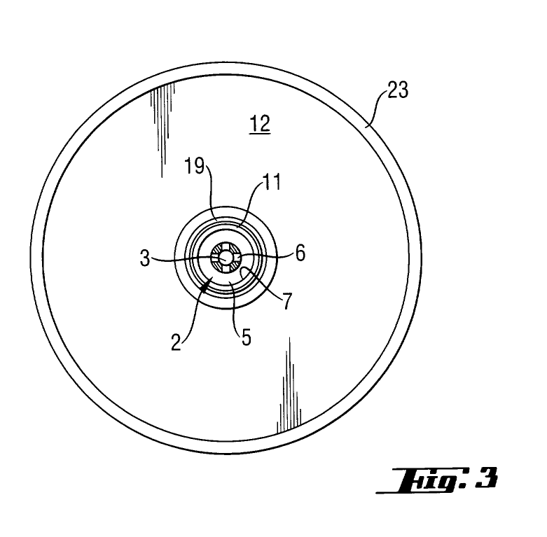

A device for rinsing a bore I according to the present invention, which is shown in FIGS. 1-3, has a rinsing head 2 extendable into a to-be-rinsed bore 1, a delivery channel 3 for delivering a rinsing medium 4 to the rinsing head 2-, and a return channel 5 for returning the rinsing medium 4 from the rinsing head 2 or from the bore 1. The delivery channel 3 has, in the region of the rinsing head 2, an outlet opening 6 for injecting the rinsing medium 4 into the bore 1. The return channel 5 has, in the region of the rinsing head 5, at least one return opening 7 for delivering the rinsing medium 4 from the bore 1.

Bar-shaped guide means 8 adjoins an end of the rinsing head 2 facing in the insertion direction. At its free end, the bar-shaped guide means 8 is provided with a handgun-shaped handle 9 with a control unit 10 incorporated therein. At its end 11 facing in the insertion direction, the bar-shaped guide means 8 has a splash guard cap 12 displaceable along the guide means 8. The splash guard cap 12 is preloaded, with respect to the guide means 8, in the insertion direction E by a spring 13, in particular, by a wire spring.

The delivery channel 3, which extends in the insertion direction E, is located somewhat in the middle of the guide means 8 and is surrounded by the return channel 5. At its insertion direction end, the delivery channel 3 is closed with a sealing cap 22. In the region of the rinsing head 2, the delivery channel 3 has a plurality of outlet openings 6 uniformly distributed over its circumference. The circular return channel 7 is offset, with respect to the outlet openings 6 of the delivery channel 3, in the direction opposite to the insertion direction E. The return channel 5 extends transverse to the insertion direction E.

The handle 9 has, at its free end, a first connector 15 that serves for delivery the rinsing medium 4 in the delivery channel 3 of the rinsing device. In addition, the guide means 8 has, in the region of the handle 9, a second connector 16 connected with the return channel 5 and connectable with a rinsing medium collector or with a filter unit for filtering the rinsing means 4.

The spring 13 has a substantially circular cross-section, and it surrounds the circumference 18 of the guide means 8. At its insertion direction end, the spring 13 contacts a stop 19 facing in the direction opposite to the insertion direction, and its opposite end, the spring 13 engages a stop 21 facing in the insertion direction and mounted on the guide means 8. The first stop 21 is formed by a circular groove formed in the outer circumference 18 of the guide means 8, the groove wall forming an O-ring that forms the stop.

The splash guard cap 12 has, preferably, a circular cross-section and is provided, at its insertion direction with a annular sealing element 23.

Though the present invention was shown and described with references to the preferred embodiment, such is merely illustrative of the present invention and are not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A device for rinsing bores (1), comprising a rinsing head (2) insertable in a bore (1); a delivery channel (3) for delivering rinsing means (4) to the rinsing head (2) and having at least one outlet opening (6) in a region of the rinsing head (2); and a return channel (5) for returning the rinsing means out of the bore (1) and having at least one return opening (7) in the region of the rinsing head (2).

2. A device according to claim 1, wherein the return opening (7) of the return channel (5) is spaced from the outlet opening (6) of the delivery channel (3) in a direction opposite to an insertion direction (E) of the rinsing head (2) into the bore (1).

3. A device according to claim 2, wherein a plane, in which the return opening (7) is located, extends substantially transverse to the insertion direction (E).

4. A device according to claim 1, wherein the return channel (5) extends coaxially with the delivery channel (3) and surrounds the delivery channel (3).

5. A device according to claim 2, wherein a plane, in which the outlet opening (6) of the delivery channel (3), extends, at least partially, transverse to the insertion direction (E).

6. A device according to claim 1, wherein the delivery channel (3) has a plurality of outlet openings (6) in the region of the rinsing head (2) distributed over an entire circumference of the delivery channel (3).

7. A device according to claim 1, further comprising guide means (8) adjoining the rinsing head (2) at an end of the rinsing head facing in a direction opposite an insertion direction (E) of the rinsing head (2).

8. A device according to claim 7, further comprising a splash guard cap (12) provided at an end (11) of the guide means (8) facing in the insertion direction (E) and projecting beyond a circumference (18) of the guide means (8).

9. A device according to claim 8, wherein the splash guard cap (12) is at lest partially displaceable along the guide means (8).

10. A device according to claim 9, further comprising spring means (13) for biasing the splash guard cap (12) in the insertion direction.
